(19) United States
(12) Patent Application Publication
(10) Pub. No.: US 2022/0268881 A1
(43) Pub. Date: Aug. 25, 2022

(54) RADAR MOUNTING STRUCTURE

(71) Applicant: HONDA MOTOR CO., LTD., Tokyo (JP)

(72) Inventors: Naoto INOUE, Tokyo (JP); Go SHIMIZU, Tokyo (JP)

(21) Appl. No.: 17/674,184

(22) Filed: Feb. 17, 2022

(30) Foreign Application Priority Data
Feb. 24, 2021 (JP) 2021-027074

(51) Int. Cl. G01S 7/02; G01S 13/931; B60Q 1/04; B60Q 1/00

(52) U.S. Cl. CPC G01S 7/028; G01S 13/931; B60Q 1/04; B60Q 1/0023; G01S 2013/93277

(57) ABSTRACT

A radar mounting structure includes: a corner upper beam; a lamp housing that houses a light source inside and that is attached to a vehicle-body upper side of the corner upper beam; and a radar configured to detect an object that is present ahead on a vehicle width direction outer side of a vehicle. The radar is disposed in front of the lamp housing so as to overlap with the lamp housing when viewed in a front-rear direction, and is fixed to the corner upper beam.

### CROSS-REFERENCE TO RELATED APPLICATIONS

The present application claims the foreign priority benefit under Title 35 U.S.C. § 119 of Japanese Patent Application No. 2021-027074, filed on Feb. 24, 2021, in the Japan Patent Office, the disclosure of which is herein incorporated by reference in its entirety.

### BACKGROUND

### Technical Field

The present invention relates to a radar mounting structure of a radar mounted on a vehicle.

### Related Art

Conventionally, as an example of structure in which a radar or the like for detecting an object present ahead of a vehicle is mounted on the vehicle, the mounting structure of a vehicle periphery monitoring device described in JP 2018-95039 A is known. In the mounting structure of the vehicle periphery monitoring device disclosed in JP 2018-95039 A, a sensor (30) having a radar function for detecting an object is attached to a resin bracket (24) installed below a lamp housing (22) of a head lamp (20).

In the mounting structure of the vehicle periphery monitoring device of JP 2018-95039 A, however, the sensor (30) is housed in a box-shaped cover body (32), and is suspended below the lamp housing (22) by a dedicated bracket (24). This means, in the mounting structure of the vehicle periphery monitoring device of JP 2018-95039 A, a dedicated component part for attaching the sensor (30) to the vehicle body is needed. Hence, there is a drawback that the number of component parts, the number of assembling person-hours, and the number of manufacturing management person-hours each increases, and thus the cost increases.

### SUMMARY

The present invention has been made in view of such circumstances, and it is an object of the present invention to provide a radar mounting structure which makes it possible to reduce the cost by reducing the number of component parts, the number of assembling person-hours, and the number of manufacturing management person-hours and to improve the appearance of a light source.

To achieve the above-described object, a radar mounting structure of an embodiment according to the present invention includes: a corner upper beam; a lamp housing that houses a light source inside and that is attached to a vehicle-body upper side of the corner upper beam; and a radar configured to detect an object that is present ahead on the vehicle width direction outer side of a vehicle. The radar is disposed in front of the lamp housing so as to overlap with the lamp housing when viewed in a front-rear direction, and is fixed to the corner upper beam.

According to the present invention, it is possible to provide a radar mounting structure which makes it possible to reduce the cost by reducing the number of component parts, the number of assembling person-hours, and the number of manufacturing management person-hours, and it is also possible to improve the appearance of the light source.

### BRIEF DESCRIPTION OF DRAWINGS

FIG. 1 is a perspective view illustrating a main part of a vehicle including a radar mounting structure of an embodiment according to the present invention.

FIG. 2 is an exploded schematic perspective view illustrating a main part of the radar mounting structure.

FIG. 3 is a diagram illustrating an example of the radar mounting structure of the embodiment according to the present invention, and is a schematic longitudinal cross-sectional view illustrating a main part of a headlamp assembly illustrating an installation state of a radar;

FIG. 4A is a component part correlation diagram of a radar mounting structure of a comparative example illustrating an attachment relationship of radar component parts mounted on an ordinary vehicle;

FIG. 4B is a diagram illustrating an example of the radar mounting structure of the embodiment according to the present invention, and is a component part correlation diagram illustrating an attachment relationship of radar component parts;

FIG. 5 is a schematic longitudinal cross-sectional view illustrating a main part of the radar mounting structure of a first modification of the embodiment according to the present invention.

FIG. 6 is a schematic exploded perspective view illustrating a main part of the radar mounting structure of a second modification of the embodiment according to the present invention.

FIG. 7 is a schematic longitudinal cross-sectional view illustrating a main part of the radar mounting structure of the second modification of the embodiment according to the present invention.

FIG. 8 is a schematic exploded perspective view illustrating a main part of the radar mounting structure of a third modification of the embodiment according to the present invention.

FIG. 9 is a schematic diagram illustrating the radar mounting structure of the third modification of the embodiment according to the present invention.

FIG. 10 is a schematic longitudinal cross-sectional view illustrating a main part of the radar mounting structure of a fourth modification of the embodiment according to the present invention.

### DETAILED DESCRIPTION

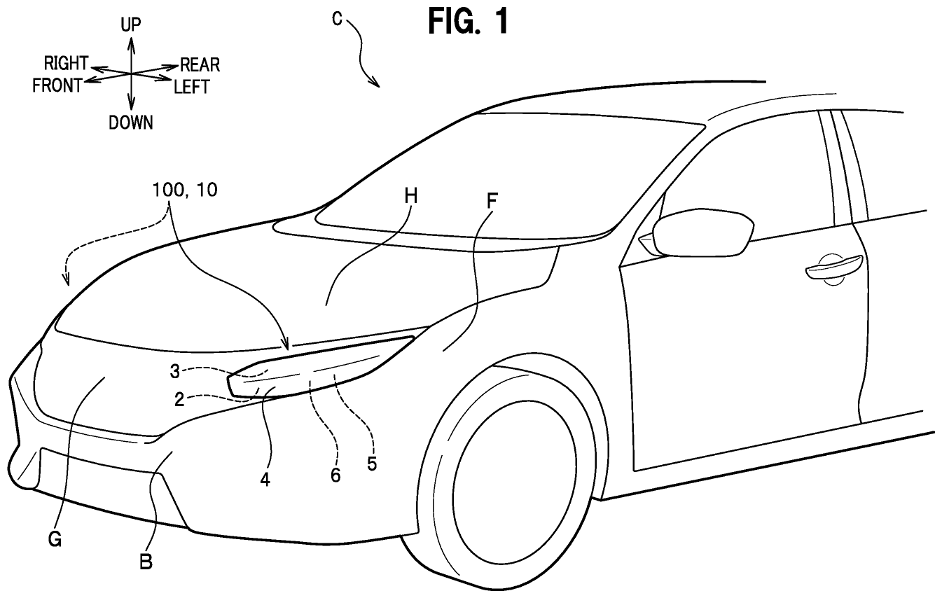

Referring to FIGS. 1 to 4B, a radar mounting structure 100 of an embodiment according to the present invention will be described. In an embodiment, the same elements are denoted by the same reference numerals, and overlapping descriptions will be omitted.

Note that, in embodiments of the present invention, “front” means a front side of a vehicle C, “rear” means a rear side of the vehicle C, “up” means a vertically upper side, “down” means a vertically lower side, and “left-right” means a vehicle width direction of the vehicle C.

First, before the radar mounting structure 100 of an embodiment according to the present invention is described, the vehicle C and a headlamp assembly 10 to which the present invention is applied will be described.

<Vehicle>

FIG. 1 is a perspective view illustrating a main part of the vehicle C including the radar mounting structure 100 of the embodiment according to the present invention.

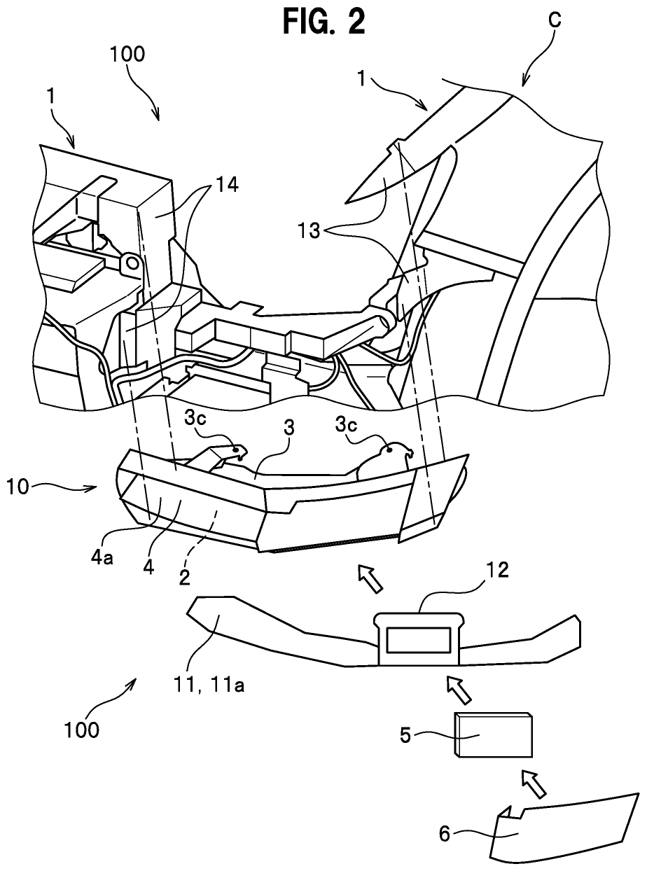

As illustrated in FIG. 1, the vehicle C includes headlamp assemblies 10 (see FIG. 2) respectively on the left and right in a front part of a vehicle body 1. The vehicle C may be any automobile that includes a light source 2 and a radar 5, and its style or type is not particularly limited. Hereinafter, as an example of the vehicle C, a case of a passenger vehicle will be described as an example.

<Headlamp Assembly>

FIG. 2 is an exploded schematic perspective view illustrating a main part of the radar mounting structure 100.

As illustrated in FIG. 2, the headlamp assembly 10 is a unit in which the light source 2 (for example, a headlamp or the like) and peripheral component parts thereof are assembled. The headlamp assembly 10 includes the light source 2, a lamp housing 3 holding the light source 2, and a lens 4 covering a front side of the light source 2. As illustrated in FIG. 1, the headlamp assembly 10 is disposed among a bonnet hood H, a bumper face B, a grille G, and a fender panel F, in a front view.

<Radar Mounting Structure>

As illustrated in FIG. 2, the radar mounting structure 100 is a fixing structure configured to arrange the radar 5 in a surrounding of the light source 2. The radar mounting structure 100 includes a corner upper beam 11, the light source 2, the lamp housing 3, the lens 4, and the radar 5, in the front part of the vehicle body. As illustrated in FIG. 1, the radar mounting structures 100 are disposed symmetrically on the left and right in the front part of the vehicle C. Hereinafter, in the embodiment, the radar mounting structure 100 disposed on the left side in the front part of the vehicle C will be described, and the description of the right side will be omitted.

<Light Source>

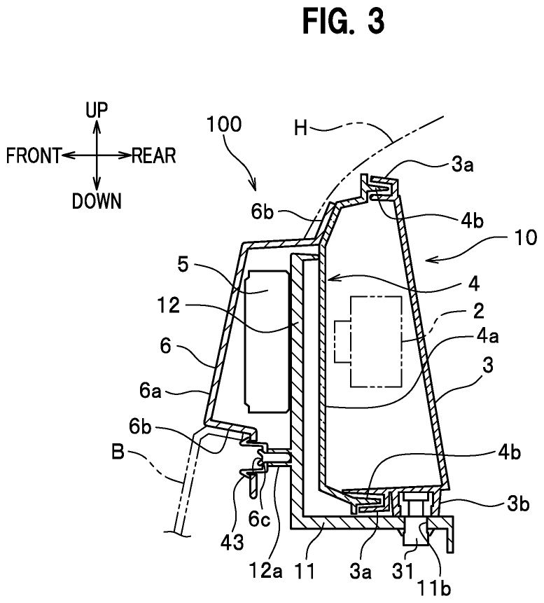

FIG. 3 is a diagram illustrating an example of the radar mounting structure 100 of the embodiment according to the present invention, and is a schematic longitudinal cross-sectional view of a main part of the headlamp assembly 10 illustrating an installation state of the radar 5.

As illustrated in FIG. 1, the light source 2 is, for example, a headlamp. As illustrated in FIGS. 2 and 3, the light source 2 is provided with the lamp housing 3 located rearwardly of the light source 2 and with the lens 4 covering the front side of the light source 2. Note that, in FIG. 3, the light source 2 is installed at a position spaced apart inward in the vehicle width direction from rear of the radar 5, and is disposed so as not to overlap with the radar 5 in a front-rear direction (see FIG. 2). That is, the light source 2 is disposed so as not to overlap with the radar 5 when viewed in the front-rear direction.

<Lamp Housing>

As illustrated in FIG. 2 or FIG. 3, the lamp housing 3 is a housing configured to house mainly the light source 2 inside. The lamp housing 3 is made up of a member that holds the light source 2 and the lens 4 from the rear side. As illustrated in FIG. 3, the lamp housing 3 includes a coupling portion 3a formed at an outer peripheral portion, a fixing portion 3b formed at a lower end portion, and vehicle body fixing bracket portions 3c (see FIG. 2) formed at an upper portion and at a lower portion. The lamp housing 3 is attached to a vehicle-body upper side of the corner upper beam 11. The lamp housing 3 is formed of an opaque resin member.

The coupling portion 3a is a portion to which an insertion portion 4b formed on an outer peripheral portion of the lens 4 is attached and fixed. The coupling portion 3a is formed in a recessed groove shape in a cross-sectional view in the outer peripheral portion of the lamp housing 3.

The fixing portion 3b is an engagement portion to which a head portion of a fastener 31 attached to a lower portion of the corner upper beam 11 is attached, so that the corner upper beam 11 is fixed to the lamp housing 3.

As illustrated in FIG. 2, the vehicle body fixing bracket portions 3c are brackets used to fasten and fix the lamp housing 3 of the headlamp assembly 10 to a wheelhouse member 13 and to a bulkhead 14 of the vehicle body 1 with volts.

<Lens>

As illustrated in FIG. 3, the lens 4 also serves as a lens cover (headlamp lens cover) disposed to cover the light source 2 (headlamp). The lens 4 is formed integrally with a lens cover portion 4a and the insertion portion 4b. The lens 4 is formed of a transparent resin material, such as an acrylic resin or a polycarbonate, which allows transmission of light emitted from the light source 2.

The lens cover portion 4a serves as a lens that deflects light emitted from the light source 2 in the forward direction and serves as a cover that covers the front side of the light source 2. The lens cover portion 4a is provided in front of the light source 2.

The insertion portion 4b is to be inserted and fixed into the coupling portion 3a of the lamp housing 3, so that the lens cover portion 4a is fixed to the lamp housing 3. The insertion portion 4b is formed on the outer peripheral portion of the lens 4.

<Corner Upper Beam>

As illustrated in FIG. 2, the corner upper beam 11 is a member that supports the headlamp assembly 10, that holds an upper end portion of a front bumper, and that holds the bumper face B. The corner upper beam 11 includes a corner upper beam body 11a extending in the vehicle width direction, a fastener installation hole 11b in which the fastener 31 configured to fix the lamp housing 3 to the corner upper beam 11 is installed, and a radar bracket portion 12 attached to the corner upper beam body 11a. The corner upper beam 11 is disposed at a front corner of the vehicle body 1. The corner upper beam 11 is attached to a lower portion of the headlamp assembly 10 (lens 4 and lamp housing 3) (see FIG. 3).

The corner upper beam body 11a includes a frame member made of a metal or a resin. The corner upper beam body 11a is fastened to the wheelhouse member 13 and to the bulkhead 14 with bolts.

The radar bracket portion 12 is made up of a rectangular frame-shaped member to which the radar 5 is attached. The radar bracket portion 12 is vertically fixed at a position spaced apart outward in the vehicle width direction from a vehicle width direction center portion of the corner upper beam body 11a. The radar bracket portion 12 includes a protrusion 12a having a tip end, to which a locking part 43 configured to couple the radar bracket portion 12 to a radar cover 6 is fixed.

The protrusion 12a is made up of a support column having a bottomed cylindrical shape for allowing the locking part 43 to be inserted and attached into a lock hole 6c of the radar cover 6. The protrusion 12a protrudes from a front surface of the radar bracket portion 12.

<Radar>

As illustrated in FIG. 2 or FIG. 3, the radar 5 is a sensor configured to detect an object that is present ahead on the vehicle width direction outer side of the vehicle C. As a specific example, the radar 5 is made up of, for example, a millimeter wave radar that detects an object by a reception unit receiving a radio wave that is emitted by a transmission unit (not illustrated) and reflected by the object. The radar 5 is disposed so as to overlap with the lamp housing 3 in the front-rear direction, i.e., the radar 5 is disposed so as to overlap with the lamp housing 3 when viewed in the front-rear direction, in front of a portion of the lamp housing 3 at which portion the light source 2 is not disposed. The radar 5 is fixed to the radar bracket portion 12 of the corner upper beam 11 disposed rearwardly of the radar 5. The front side of the radar 5 is covered by the radar cover 6.

<Radar Cover>

As illustrated in FIG. 3, the radar cover 6 includes: a radar cover portion 6a provided to cover the front side of the radar 5; and a support portion 6b formed on an outer peripheral portion of the radar cover portion 6a. The radar cover 6 is formed of, for example, an opaque resin.

As the radar 5 covered with the radar cover portion 6a is disposed at a front end portion of the vehicle body 1 so as not to be directly visually recognized, the appearance is good.

The support portion 6b is a portion with which the lens cover portion 4a and the corner upper beam 11 hold the radar cover 6. The support portion 6b, located on the outer peripheral portion of the radar cover 6, is attached to the lens cover portion 4a and to the corner upper beam 11, so that the radar cover 6 is fixed to the lens cover portion 4a and to the corner upper beam 11.

<<Operations>>

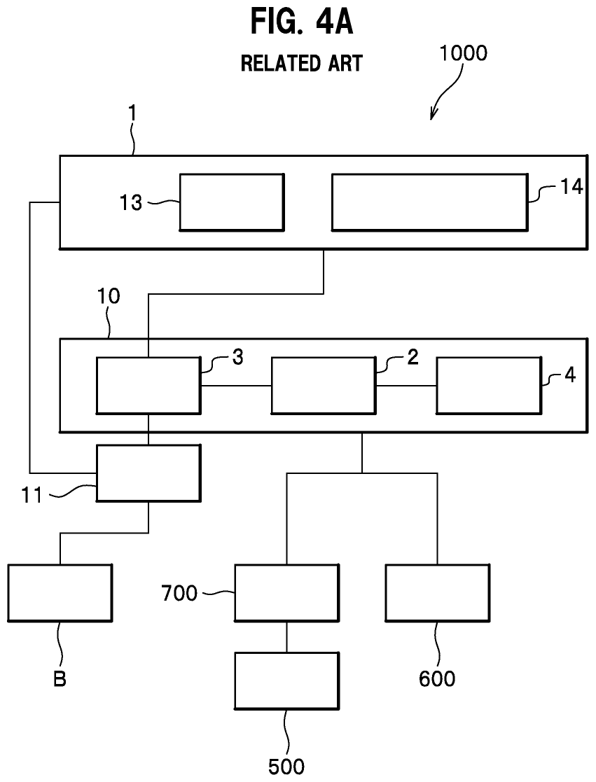

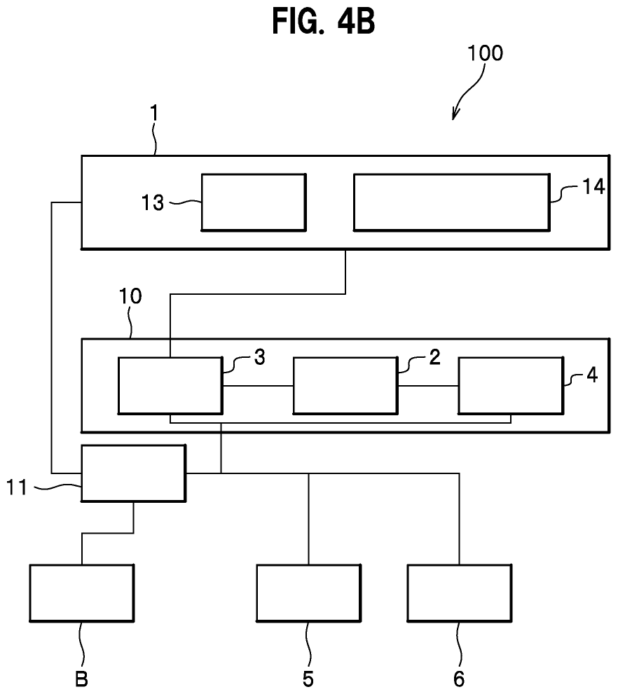

The radar mounting structure 100 of the above-described embodiment according to the present invention is basically configured as described above. Next, operations and effects of the radar mounting structure 100 will be described with reference to FIGS. 1 to 4B, in comparison with a comparative example of a radar mounting structure 1000 mounted on an ordinary vehicle, illustrated in FIG. 4A.

FIG. 4A is a component part correlation diagram of the radar mounting structure 1000 of a comparative example illustrating an attachment relationship of radar component parts mounted on an ordinary vehicle. FIG. 4B is a diagram illustrating an example of the radar mounting structure 100 of the above-described embodiment according to the present invention, and is a component part correlation diagram illustrating an attachment relationship of radar component parts. Black lines in FIGS. 4A and 4B each represent a fix relationship between elements. In addition, an overlap of rectangular frames represents a conceptual inclusion relationship of elements.

As illustrated in FIGS. 4A and 4B, in both cases of the radar mounting structure 1000 of the comparative example and the radar mounting structure 100 of the above-described embodiment according to the present invention, the lamp housing 3 of the headlamp assembly 10 is fixed to the wheelhouse member 13 and to the bulkhead 14 of the vehicle body 1. The light source 2, in both cases of the comparative example and the above-described embodiment according to the present invention, is housed in a housing made up of the lamp housing 3 and the lens 4.

In addition, the corner upper beam 11, in both cases of the comparative example and the above-described embodiment according to the present invention, is fixed to the lamp housing 3 and to the vehicle body 1. Further, the bumper face B, in both cases of the comparative example and the above-described embodiment according to the present invention, is fixed to the corner upper beam 11.

As illustrated in FIG. 4A, a radar 500 of the radar mounting structure 1000 of the comparative example is fixed to a radar bracket 700, which is attached to the headlamp assembly 10.

On the other hand, the radar 5 of the radar mounting structure 100 of the embodiment according to the present invention is attached to the corner upper beam 11, as illustrated in FIGS. 3 and 4B.

Therefore, for the radar 5 of the radar mounting structure 100 of the embodiment according to the present invention, there is no need of the radar bracket 700 dedicated to attaching the radar 500 to the headlamp assembly 10 in the radar mounting structure 1000 of the comparative example illustrated in FIG. 4A. Therefore, the radar mounting structure 100 of the embodiment according to the present invention makes it possible to reduce the number of component parts, the number of assembling person-hours, and thus the cost. In addition, the accuracy of the attachment of the radar 5 to the vehicle body 1 can be improved by the radar 5 being directly attached to the corner upper beam 11.

In addition, as illustrated in FIG. 4A, a radar cover 600 of the radar mounting structure 1000 of the comparative example is attached to the headlamp assembly 10.

On the other hand, the radar cover 6 of the radar mounting structure 100 of the embodiment according to present invention is attached to the corner upper beam 11 and to the lens 4, as illustrated in FIGS. 3 and 4B. Therefore, the radar cover 6 of the embodiment according to the present invention is rigidly fixed and the accuracy of the attachment of the radar cover 6 to the vehicle body 1 is improved, compared to the radar cover 600 of the comparative example. Moreover, as the accuracy of the attachment of the radar cover 6 to the bumper face B is also improved, the accuracy of gap setting and step setting of the radar cover 6 as a design component part is improved, leading to an improvement in the appearance.

In addition, regarding the positional relationship between the radar cover 6 and the radar 5, the radar cover 6 and the radar 5 are assembled to the same corner upper beam 11, leading to an improvement in the performance and accuracy of the radar 5.

As described above, as illustrated in FIG. 2 or FIG. 3, the radar mounting structure 100 of the embodiment according to the present invention includes the corner upper beam 11, the lamp housing 3 that houses the light source 2 inside and that is attached to the vehicle-body upper side of the corner upper beam 11, and the radar 5 configured to detect an object that is present ahead on the vehicle width direction outer side of the vehicle C. The radar 5 is disposed in front of the lamp housing 3 so as to overlap with the lamp housing 3 when viewed in the front-rear direction, and is fixed to the corner upper beam 11.

According to such a configuration, the radar 5 is disposed so as to overlap with the lamp housing 3 when viewed in the front-rear direction, in front of a portion of the lamp housing 3 at which portion the light source 2 is not disposed. Therefore, the radar 5 does not block the light emitted from the light source 2. The radar 5 is fixed to the corner upper beam 11 of the vehicle body 1, and thus the radar 5 is rigidly attached to the vehicle body 1 without positional deviation, leading to an improvement in the accuracy of the attachment position with respect to the vehicle body 1. Therefore, the present invention makes it possible to eliminate a bracket dedicated to attaching the radar 5. Accordingly, in association with the integration of the component parts, it is possible to reduce the cost by reducing the number of component parts, the number of assembling person-hours, and the number of manufacturing management person-hours and to improve the appearance of the light source.

[First Modification]

Heretofore, an embodiment according to the present invention have been described in detail with reference to the drawings. However, the present invention is not limited to the above-described embodiment, and can be appropriately modified without departing from the gist of the present invention.

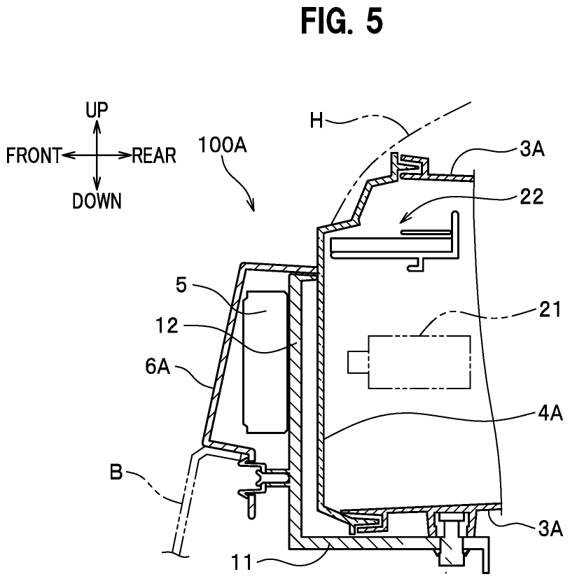

FIG. 5 is a schematic longitudinal cross-sectional view illustrating a main part of a radar mounting structure 100A, which is a first modification of the radar mounting structure 100 of the above-described embodiment according to the present invention.

The lens 4 described in the above-described embodiment (see FIGS. 2 and 3) is not limited to a lens that covers only one type of light source 2 (for example, a headlamp). As illustrated in FIG. 5, a lens 4A may cover a first light source 21 made up of a headlamp, and may cover a second light source 22 made up of signal lamps, non-limiting examples of which include a turn signal lamp and a position lamp.

In this case, the second light source 22 is disposed rearwardly of and at a higher position than the radar 5. For this reason, the light emitted from the second light source 22 is not blocked by the radar 5.

In addition, a lamp housing 3A may house a plurality of light sources 2, such as the first light source 21 and the second light source 22.

In this case, a radar cover 6A disposed on the front side of the lens 4A is made up of an opaque member disposed in front of the radar 5 to cover the radar 5. Therefore, the radar cover 6A is capable of preventing the radar 5 from being visually recognized from the outside of the vehicle, leading to an improvement in the appearance.

Also in such a configuration, in the radar mounting structure 100A, the corner upper beam 11 is capable of rigidly holding the radar 5 and the lamp housing 3A.

[Second Modification]

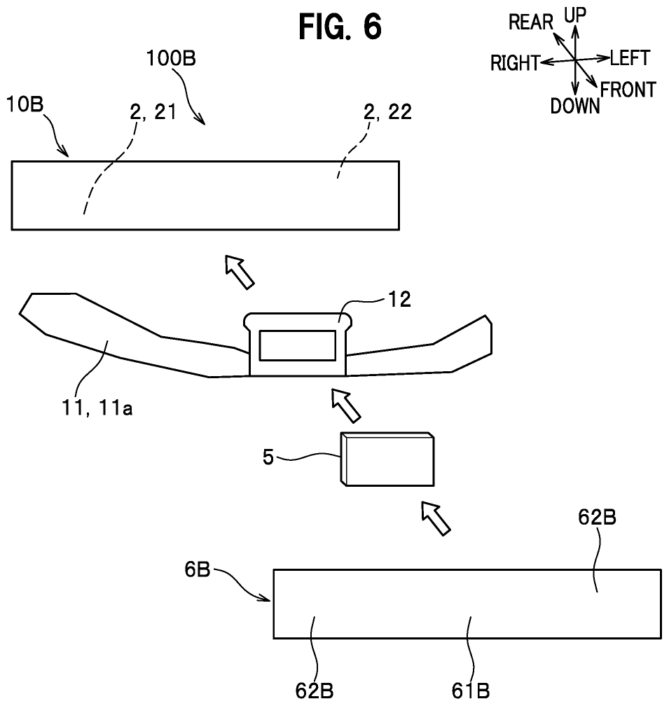

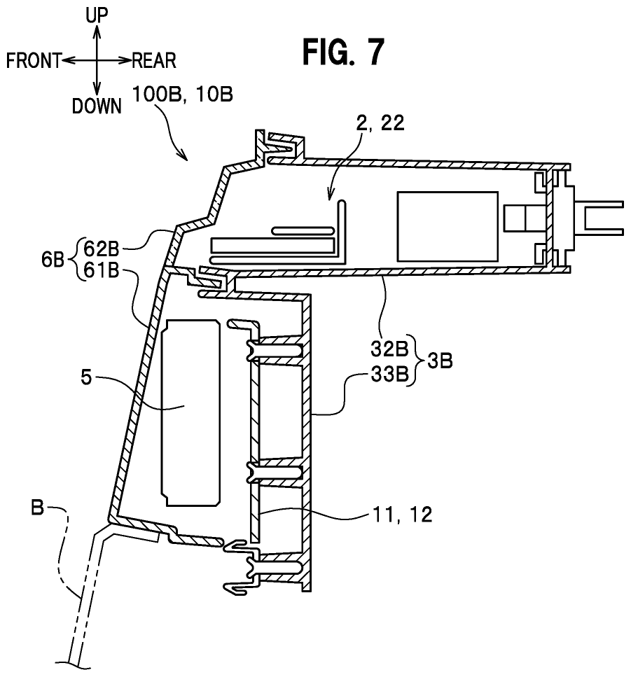

FIG. 6 is a schematic exploded perspective view illustrating a main part of a radar mounting structure 100B, which is a second modification of the radar mounting structure 100 of the above-described embodiment according to the present invention. FIG. 7 is a schematic longitudinal cross-sectional view illustrating a main part of the radar mounting structure 100B.

The radar cover 6 described in the above embodiment (see FIG. 2) as covering the radar 5 is not limited to those that cover only the radar 5. As illustrated in FIGS. 6 and 7, a radar cover 6B covering the radar 5 may be configured to serve also as a lens covering the light sources 2.

In this case, the radar cover 6B includes, for example, a radar cover portion 61B covering the radar 5 provided in the radar bracket portion 12, and light source lens cover portions 62B covering the light sources 2 provided in a headlamp assembly 10B. The radar cover 6B is integrally formed by two-color molding, joining, or bonding the radar cover portion 61B made of an opaque resin and the light source lens cover portions 62B each made of a transparent resin, and covers, as a single member, the radar 5 and the light sources 2.

The radar cover portion 61B is disposed in front of the radar bracket portion 12 and the radar 5. The light source lens cover portions 62B are disposed respectively on the left and right of the radar cover portion 61B, and are disposed respectively in front of the first light source 21 and the second light source 22 to cover them.

In addition, two types of light sources 2 including the first light source 21 (headlamp) and the second light source 22 (signal lamp(s)) are installed in the headlamp assembly 10B. The entire front side of the headlamp assembly 10B is covered with the radar cover 6B disposed in front of the first light source 21 and the second light source 22 with the corner upper beam 11 interposed therebetween. The first light source 21 is disposed at a position spaced apart inward in the vehicle width direction from the radar bracket portion 12 and the radar 5, in a front view. The signal lamps of the second light source 22 are disposed respectively at a position spaced apart upward from the radar bracket portion 12 and the radar 5 and at a position spaced apart outward in the vehicle width direction, in a front view.

In addition, a lamp housing 3B includes a light source housing portion 32B that houses the light sources 2 and a housing portion 33B that houses the radar bracket portion 12 holding the radar 5.

According to the second modification of the above-described embodiment according to the present invention, the light source lens cover portions 62B of the radar cover 6B is configured to serve also as lamp lenses that that cover the light sources 2. Therefore, a cover dedicated to the radar 5 is not necessary, leading to a reduction in the number of component parts and the number of assembling person-hours. As the radar cover 6B is configured to serve also as the lenses that cover the light sources 2 and thus the radar cover 6B is rigidly attached to the vehicle body 1 without positional deviation, the accuracy in the attachment position with respect to the vehicle body 1 is improved.

[Third Modification]

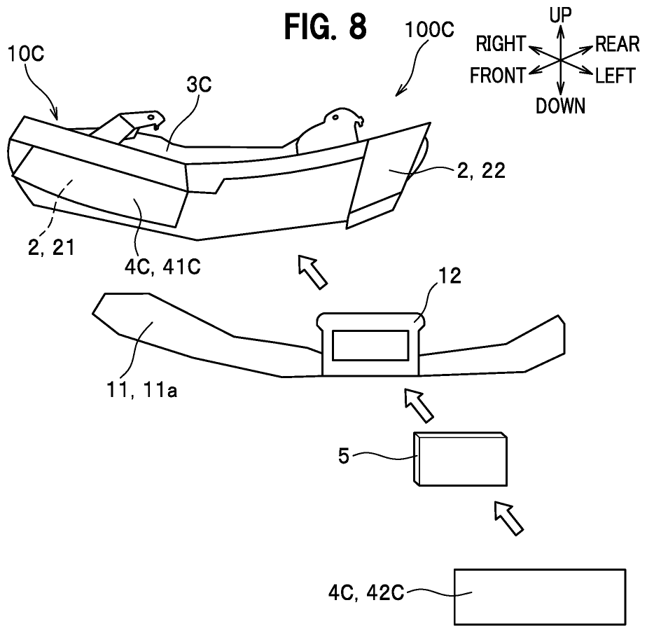

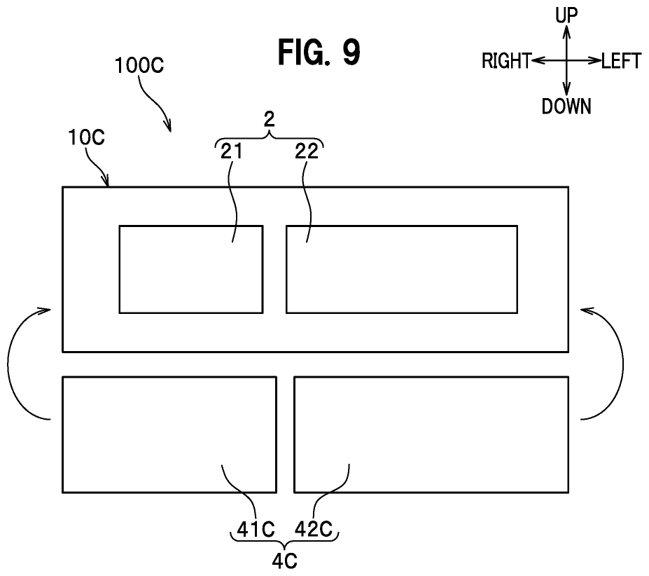

FIG. 8 is a schematic exploded perspective view illustrating a main part of a radar mounting structure 100C, which is a third modification of the radar mounting structure 100 of the above-described embodiment according to the present invention. FIG. 9 is a schematic diagram illustrating the radar mounting structure 100C.

Regarding the radar 5 of the above-described embodiment, the radar cover 6 is not limited to those that cover only the radar 5 as illustrated in FIG. 2. As illustrated in FIG. 8 or FIG. 9, the light sources 2 provided in a headlamp assembly 10C of the radar mounting structure 100C may include the first light source 21 and the second light source 22, the first light source 21 and the second light source 22 may be respectively covered with a first light source lens 41C and a second light source lens 42C, and the radar 5 may be covered with the second light source lens 42C.

In addition, the first light source 21 may be a headlamp, and the second light source 22 may be signal lamps.

In this case, in the headlamp assembly 10C, the first light source 21 of the headlamp and the second light source 22 including signal lamps such as a position lamp and a turn signal lamp are installed.

The first light source 21 is made up of a halogen lamp, a discharge (HID) lamp, or an LED. The first light source 21 is covered by the first light source lens 41C disposed in front of the first light source 21.

The second light source 22 is made up of, for example, LEDs. The second light source 22 is covered with the second light source lens 42C with the corner upper beam 11 and the radar 5, which are disposed on the front side, interposed between the second light source 22 and the second light source lens 42C.

The first light source 21 and the second light source 22 are housed in a lamp housing 3C. A lens 4C includes: the first light source lens 41C covering the front side of the first light source 21; and the second light source lens 42C covering the front side of the second light source 22 and the radar 5. Therefore, the second light source lens 42C is disposed in front of the second light source 22 and the radar 5.

According to the third modification of the above-described embodiment according to the present invention, the second light source lens 42C serves also as a radar cover covering the radar 5. Therefore, a cover dedicated to the radar is not necessary. Accordingly, the number of component parts and the number of component parts management person-hours are reduced, leading to a reduction in the cost.

In addition, the maintenance of the radar 5 can be conducted by simply detaching the second light source lens 42C, leading to an improvement in the ease of maintenance at the time of replacing the radar 5.

In addition, in general, when the headlamp, which is the first light source 21, is detached from the lamp housing 3C or from the first light source lens 41C, so-called aiming for calibrating the orientation of the main optical axis in the light distribution characteristics is needed in order to cause the headlamp to operate correctly. This takes time and effort.

On the other hand, the radar 5 of the third modification of the above-described embodiment according to the present invention is covered by the second light source lens 42C covering the signal lamp(s), which is the second light source 22. Therefore, a maintenance can be easily conducted by detaching the cover (second light source lens 42C) of the signal lamp(s). Therefore, in the event of conducting the maintenance of the radar 5, the radar 5 can be detached by simply detaching the signal lamp housing. Therefore, it is not necessary to detach the first light source lens 41C of the headlamp. Therefore, it is not necessary to conduct the aiming which is to be conducted in the event of detaching the headlamp, and the maintenance is facilitated.

[Fourth Modification]

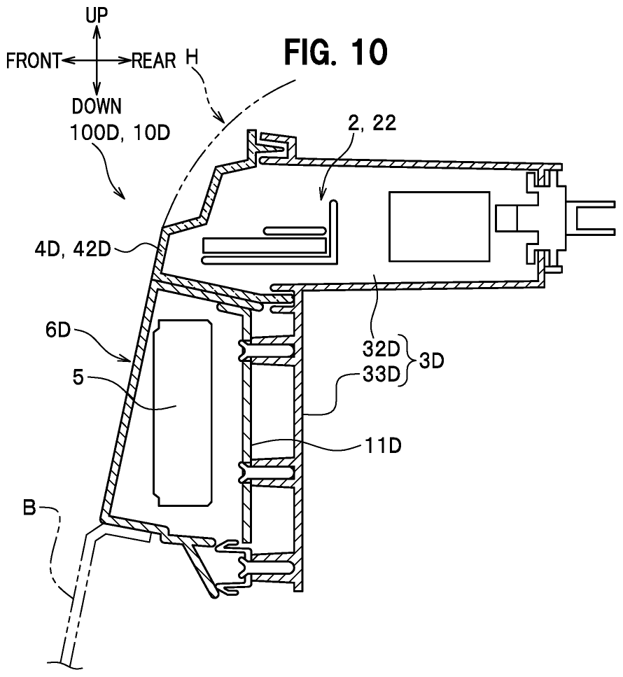

FIG. 10 is a schematic longitudinal cross-sectional view illustrating a main part of a radar mounting structure 100D, which is a fourth modification of the radar mounting structure 100 of the above-described embodiment according to the present invention.

As in the radar mounting structure 100D of the fourth modification of the above-described embodiment according to the present invention illustrated in FIG. 10, a radar cover 6D may be fixed to a lamp housing 3D separately from a lens 4D of the light source 2 provided in a headlamp assembly 10D of the radar mounting structure 100D.

In this case, the lens 4D serving also as a light source cover includes: a first light source lens (not illustrated) covering the first light source 21 (not illustrated); and a second light source lens 42D covering the second light source 22. The first light source lens (not illustrated) does not extend to reach a lower end of a lower housing portion 33D, and is fixed to the lower housing portion 33D disposed to extend downward from an upper housing portion 32D. The second light source lens 42D is attached to the upper housing portion 32D to cover the front side of the upper housing portion 32D.

The radar 5 may be fixed to the lamp housing 3D with a corner upper beam 11D interposed between the radar 5 and the lamp housing 3D, or may be directly fixed to the lamp housing 3D.

In addition, the radar cover 6D is fixed to the lamp housing 3D, and is fixed in front of the lower housing portion 33D so as to cover the radar 5. The radar cover 6D is provided to be adjacent to a lower side of the second light source lens 42D in a longitudinal cross-sectional view.

As described above, the radar cover 6D is fixed to the lamp housing 3D with no relation to the lens 4D for the light source 2, leading to an improvement in the accuracy of the attachment of the radar cover 6D with respect to the vehicle body (not illustrated) and leading to a reduction in the number of component parts.

What is claimed is:

1. A radar mounting structure comprising:
a corner upper beam;
a lamp housing that houses a light source inside and that is attached to a vehicle-body upper side of the corner upper beam; and
a radar configured to detect an object that is present ahead on a vehicle width direction outer side of a vehicle,
wherein the radar is disposed in front of the lamp housing so as to overlap with the lamp housing when viewed in a front-rear direction, and is fixed to the corner upper beam.

2. The radar mounting structure according to claim 1, further comprising a radar cover configured to cover the radar and to serve also as a lens covering the light source.

3. The radar mounting structure according to claim 1,
wherein the light source includes a first light source and a second light source,
wherein the first light source and the second light source are respectively covered by a first light source lens and a second light source lens, and
wherein the radar is covered by the second light source lens.

4. The radar mounting structure according to claim 2,
wherein the light source includes a first light source and a second light source,
wherein the first light source and the second light source are respectively covered by a first light source lens and a second light source lens, and
wherein the radar is covered by the second light source lens.

5. The radar mounting structure according to claim 3,
wherein the first light source comprises a headlamp, and
wherein the second light source comprises a signal lamp.

6. The radar mounting structure according to claim 4,
wherein the first light source comprises a headlamp, and
wherein the second light source comprises a signal lamp.
